(19) United States
(12) Patent Application Publication
(10) Pub. No.: US 2017/0066023 A1
(43) Pub. Date: Mar. 9, 2017

(54) DEVICE FOR CLEANING PLANT POTS

(71) Applicant: M. Stolze Holding B.V., De Lier (NL)

(72) Inventor: Martin STOLZE, DE LIER (NL)

(21) Appl. No.: 15/255,317

(22) Filed: Sep. 2, 2016

(30) Foreign Application Priority Data
Sep. 3, 2015 (NL) 1041459

(51) Int. Cl. B08B 9/087; B08B 3/10; A46B 13/02; B08B 9/08

(52) U.S. Cl. CPC B08B 9/087; B08B 9/0826; B08B 3/10; A46B 13/02

(57) ABSTRACT

Device for cleaning the outer surface of the circumferential wall of plant pots, including:
a frame;
a pot track arranged on the frame, which track extends from an input end to an output end and forms a support surface for the plant pots;
a movement device for moving the plant pots from the input end to the output end;
a rotation device for rotating the plant pots about their pot axis;
a brush for brushing the outer surface of the circumferential wall of the plant pots during the movement;
a first brush drive for rotating the brush about a lying axis; and
a second brush drive for moving the rotating brush up and down, while engaging the pot's circumferential wall, between a first position and a second position, wherein the first position is situated at a lower level than the second position.

### FIELD OF THE INVENTION

The invention relates to a device and a method for cleaning plant pots.

### BACKGROUND OF THE INVENTION

In the course of cultivation, plant pots will become dirty with soil and/or mud. The sometimes grubby look may be an impediment to successful sales. It is therefore customary to clean plant pots before they are offered for sale to the consumer. This can be done using a hand brush and water, however, this requires a lot of effort and provides low capacity. Machines are available and have been invented for cleaning large quantities of plant pots, in which machines the plant pots to be washed are placed on a conveyor belt and then passed along one or more rotating brushes.

An example of such a machine has been described in EP 1.922.917, which machine comprises a conveyor belt, having an elongated brush on either side thereof, which brush rotates about a horizontal axis and to which water is dispensed, and a rope engaging the pot wall and being driven at a speed exceeding the speed of the conveyor belt in order to have the pots rotate about their pot axis. The distance from the rope belt to the brush can be adjusted, and therewith the brush pressure on the pots as well. In order to enable the brush to reach the circumferential wall of the pots over the full height, the conveyor belt is positioned at an ascending slope. The size of the angle of inclination can be adjusted, in order to be adapted to the height of the pots to be washed. When washing the plant pots using this machine, surfaces of the circumferential wall will only be engaged by the brush for a limited period of time. The top surfaces only in a first path section and the bottom surfaces only in an end path section. In case of truncated conical pot walls the rope's pressing force furthermore decreases the higher the position of the pots during conveying, due to the slope.

### SUMMARY OF THE INVENTION

It is an object of the invention to provide a device and method for cleaning plant pots with which the pot walls can be cleaned reliably.

It is an object of the invention to provide a device and method for cleaning plant pots with which the pot walls can be cleaned efficiently.

It is an object of the invention to provide a device and method for cleaning plant pots with which the pot walls can be cleaned thoroughly.

For achieving at least one of these objects, according to one aspect, the invention provides a device for cleaning the outer surface of the circumferential wall of plant pots, comprising:
a frame;
a pot track arranged on the frame, which track extends from an input end to an output end and forms a support surface for the plant pots;
a movement device for moving the plant pots from the input end to the output end;
a rotation device for rotating the plant pots about their pot axis during said movement;
a brush for brushing the outer surface of the circumferential wall of the plant pots during said movement;
a first brush drive for rotating the brush about a lying axis; and
a second brush drive for moving the rotating brush up and down, while engaging the outer surface of the pot's circumferential wall, between a first position and a second position, wherein the first position is situated at a lower level than the second position.

Because of the rotatingly driven brush moving up and down along the outer surface of the pot wall, while the rotating pot is moved in a path along the brush, an effective cleaning of the circumferential wall of the pots is effected in a simple manner. The brush's diameter can remain within limits.

If the first brush drive has been configured for having the brush rotate in the same direction, in both the upward stroke and in the downward stroke of the brush, the relative speed of the bristles with respect to the pot wall will in the upward stroke differ from the speed in the downward stroke, which may increase the effectiveness of brushing.

If water is supplied to the brush and/or the pot wall, there may be question of a pre-soaking effect on the dirt deposited on the pot wall that has not been removed in a first round of brushing.

If the brush is rotated both in the upward stroke and in the downward stroke of the brush with a vertically downward directional component at the location of the contact with the plant pots, the stability of the pots is enhanced and the spreading of dirt that has been brushed off can be kept within limits.

The set-up with a brush going up and down makes it easy to step up the cleaning, wherein the second brush drive is configured for repeatedly moving the brush up and down in the period in which a plant pot is moved from the input end to the output end by the movement device.

For an easy adjustment to the height of the pots to be cleaned, the speed, the size and/or the level of the up-and-down stroke of the brush can be adjustable relative to the pot track. The height of the pot track can be adjustable as well.

In one embodiment the rotation device is configured for continuously rotating the plant pots about their pot axis during their movement from the input end to the output end about their axis. The rotation device may comprise a circumferentially extending, elongated element, such as a belt, cord, chain or rope belt, which in an engagement path engages onto the circumferential wall of the plant pots, and comprise a drive for driving the elongated element in said engagement path. The driving direction of the elongated element onto the pots may be the same as the movement direction of the plant pots.

The movement device may comprise a driven belt conveyor, which forms the support surface for the plant pots, such as a flat belt conveyor, link belt conveyor, cord belt conveyor, etc.

The brush can be elongated and have a length of at least almost the distance between the input end and the output end. The lying axis of the brush can be parallel to the pot support surface of the pot track, in particular parallel to the movement direction of the pots on the pot track. The lying axis may include a small, for instance a few degrees, with the horizontal plane. In one embodiment, the lying axis is parallel to the horizontal plane. The lying axis may include a small angle, for instance a few degrees, with the movement direction of the pots, considered in projection on a horizontal plane.

According to a further aspect, the invention provides a method for cleaning the outer surface of the circumferential wall of plant pots having a pot axis, comprising the following steps:
moving the plant pots in series on a pot track;
using a rotating brush for brushing the outer surface of the circumferential wall of the plant pots during their movement on the pot track;
rotating the plant pots, in particular during their movement on the pot track, to allow the brush to be active all around the outer surface of the circumferential wall; and
moving the brush up and down during brushing.

The up-and-down stroke may extend over the height of the circumferential wall of the pot to be cleaned, between the bottom edge and upper edge of the pot. If the pot wall needs to be cleaned mainly in an upper or a lower section, the stroke can be adapted thereto. Usually the lower section will be dirtiest.

In one embodiment the brush is moved up and down between a first position in which the axis of the brush is at least almost at the same height as the bottom edge of the pot wall and a second position in which the axis of the brush is located at a higher level and the brush engages the pot wall at a distance from the bottom edge. In one embodiment, in the second position the brush axis is at least almost at the same height as the upper edge of the pot wall.

During the movement of a plant pot over the pot track the brush can be moved up and down relative to said plant pot several times.

The brush can be rotated in a rotation direction that is downward where the plant pots are being engaged by the brush. If the circumferential speed of the brush, where it engages the outer surface of the circumferential wall of the pot, exceeds the largest speed with which the brush is moved upwards, the bristles will always exert a downward force onto the plant pot.

During their movement over the pot track, the plant pots can be continuously rotated about their pot axis.

In one embodiment water is dispensed to the brush and/or the plant pots for washing the outer surface of the circumferential wall of the plant pots.

The brush may be straight circle cylindrical. In another embodiment, the brush may be slightly truncated with a circular cross section.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### BRIEF DESCRIPTION OF THE DRAWINGS

The invention will be elucidated on the basis of an exemplary embodiment shown in the attached drawings, in which:

FIG. 1 shows an isometric view of an exemplary embodiment of a plant pot cleaner according to the invention;

FIGS. 2A and 2B show a top view and an end view of the device of FIG. 1, respectively; and

FIGS. 3A-C show a top view, and two end views of the device of FIG. 1, respectively, during use.

### DETAILED DESCRIPTION OF THE INVENTION

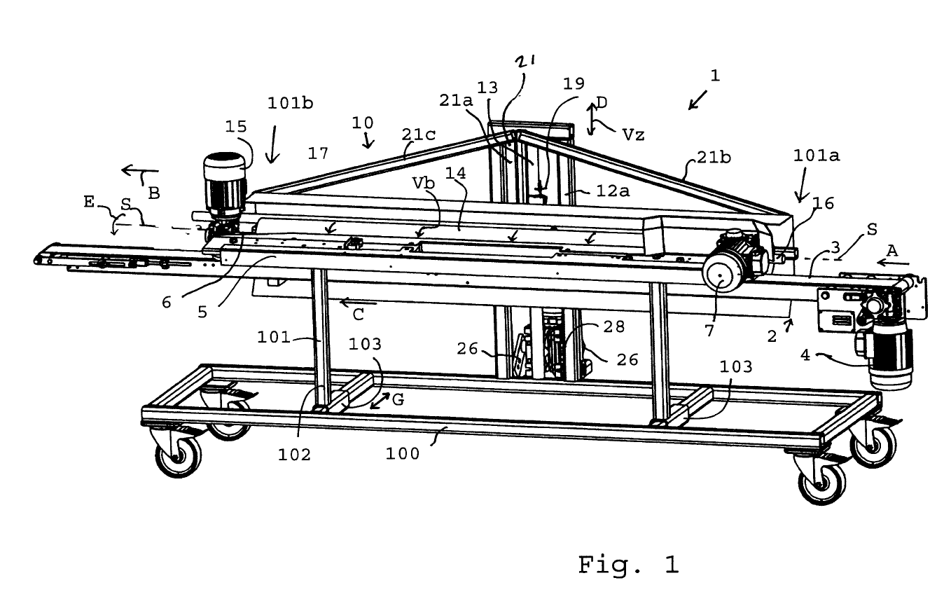

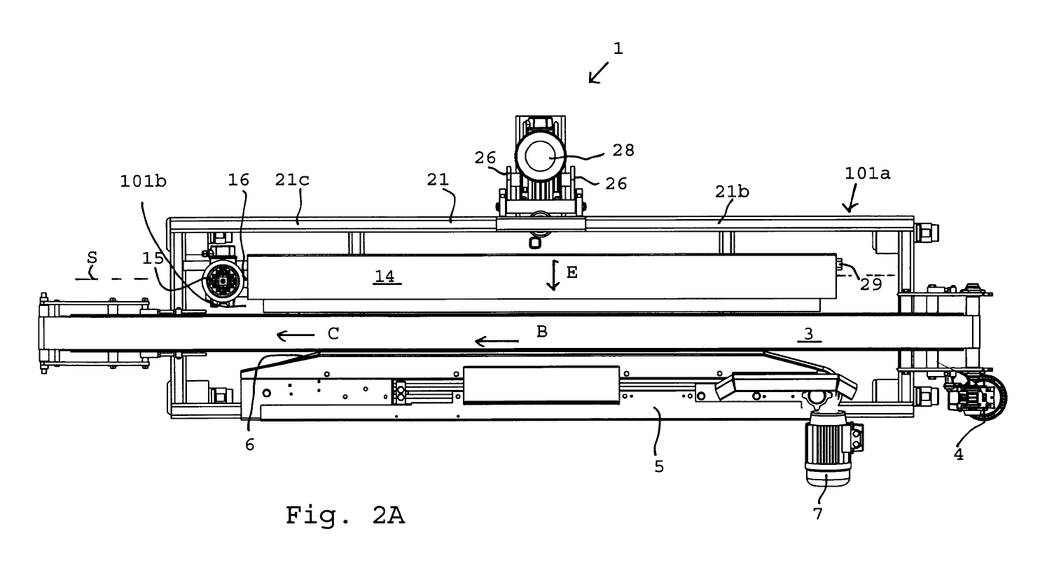

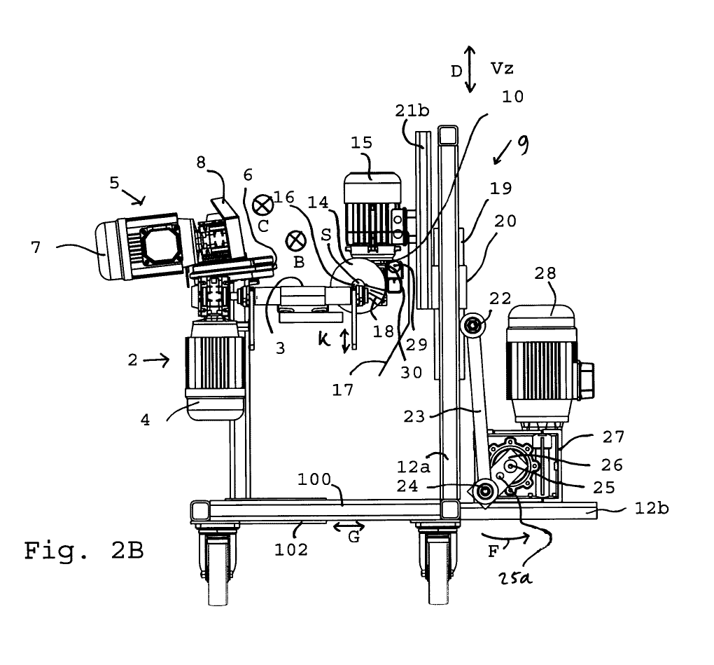

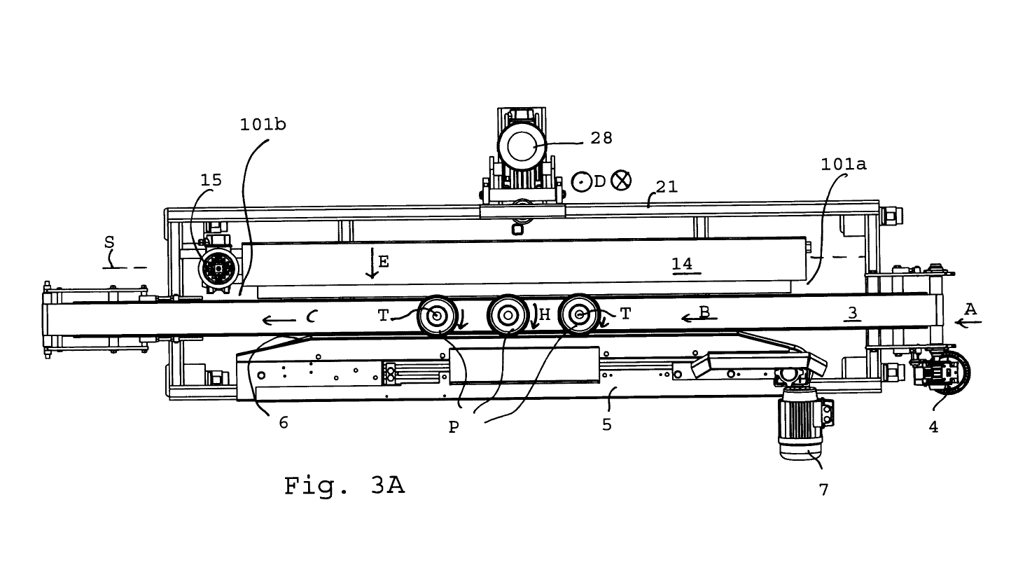

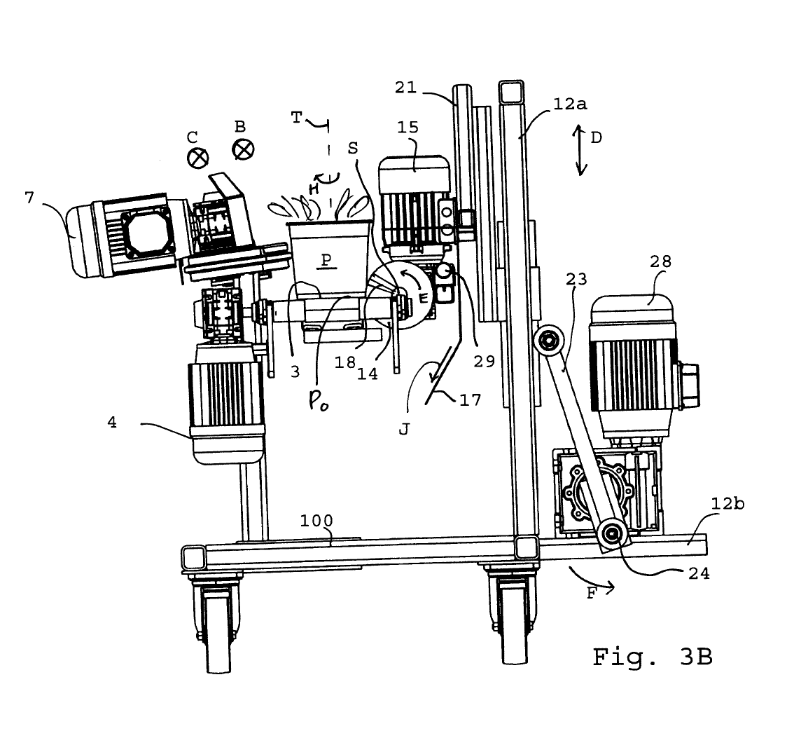

The device 1 in FIG. 1 comprises a frame 100, to be positioned on a floor, on which frame are supported a belt conveyor 2, a pot rotation device 5 and a brushing device 9.

The belt conveyor 2 comprises a belt 3 for supporting pots, which belt extends horizontally and forms a pot track between an input end 101a and an output end 101b, and which is driven by an electromotor 4, in the direction B.

The pot rotation device 5 is positioned adjacent to and diagonally over the belt 3 and comprises a rope belt 6 driven by an electromotor 7 in direction C. The pot rotation device 5 is supported on the frame 100 via columns 101 and tubes 102. The tubes 102 can be shifted on transverse tubes 103 of frame 100 and can be secured at the wanted location in order to adjust the horizontal distance of the rope belt 6 to the belt 3, direction G, depending on the pot size. A splashboard 8 screens off the motor 7 from the water and dirt released during the cleaning of pots.

The brushing device 9 comprises a brushing unit 10 having a straight circle-cylindrical brush 14 with bristles 18, that has been attached to a shaft 16 having a horizontal brush axis S, extending parallel to the pot support surface of the belt 3. The shaft 16 and therefore the brush 14 is rotatable at a speed Vb in direction E by an electromotor 15. The brushing unit 10 further comprises a splashboard 17.

The brushing device 9 further comprises a holder 11 for the brushing unit 10. Said holder 11 comprises an upright frame 12a and a base 12b attached to the frame 100. The upright frame 12a comprises a vertical guide 13, over which a sleeve 19 can be slid up and down in directions D. A ring 20 has been attached to the sleeve 19, on which ring a frame 21 has been attached. The frame 21 comprises a column 21a and two shores 21b,c. The brushing unit 10 has been attached to the frame 21. Via a hinge 22 and a link rod 23 at hinge 24, the sleeve 19 has been connected to crank arm 26. The crank arm 26 has been attached to a drive shaft 25 which through the intermediary of transmission 27 is driven in direction F by electromotor 28. Rotation of the crank arm 26 thus results in an up-and-down motion D of the brushing unit 10.

The brushing unit 9 has further been provided with a water supply pipe 29 extending alongside the brush 14, which has been provided with a series of holes 30 for dispensing water to the upper side of the brush 14, distributed over its length.

In operation the plant pots P to be cleaned are supplied over a supply conveyor that is not shown in the direction A, and they are transferred to the input end 101a of the belt conveyor 2.

The outer surface of the circumferential wall (the sidewall) of the plant pots P is engaged at the one side by the brush 14, and at the other side by the rope belt 6. As in the direction C the rope belt 6 has a speed that differs from the speed of the belt 3 in direction B, for instance exceeding it, wherein for instance the rope belt can have a speed of 15 m/min and the belt a speed of 10 m/min, the pots P are rotated once or several times about their (vertical) pot axis T, direction H, during conveying in direction B. The pot axis is perpendicular to the pot bottom.

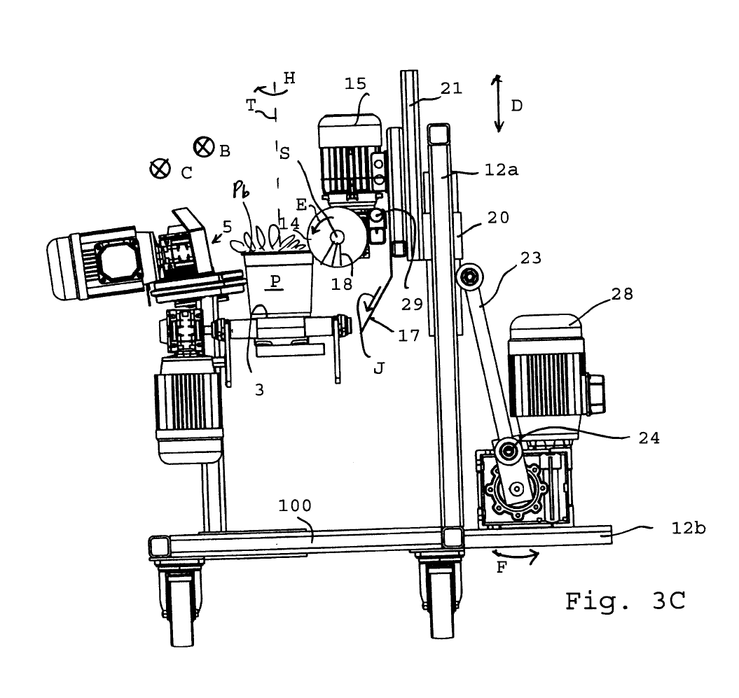

During conveying the plant pots P from the input end 101a to the output end 101b (FIGS. 3A-C, in FIG. 3A the plants have been left out), the brush 14 is rotated in direction E, and moreover the brushing unit 10 is moved up and down, directions D, between a low position (FIG. 3B) in which the brush axis S is at the same height as the bottom edge Po of the pot wall and a high position (FIG. 3C) in which the brush axis S is at the same height as the upper edge Pb of the pot wall. The pots for instance have a diameter of 14 cm and a height of 14 cm. The brush is for instance rotated at a circumferential speed Vb of 30 m/min (measured at the normal brush outer surface). This process takes place at a speed Vz (vertical speed when passing through the mid-position of the up-and-down motion), of for instance 20 m/min, which is chosen such that during the time in which a pot P is moved from the input end 101a to the output end 101b the brush 14 has been moved up and down along the outer surface of the circumferential wall of the pots several times. In the rotation of the brush, the bristles 18 are moved downwards along the outer surface of the pots P. The brush circumferential speed Vb, in particular the (downward) speed of the brush where the bristles contact the outer surface of the circumferential wall of the pot, exceeds Vz so that the brush at all times exerts a downward force on the outer surface of the circumferential walls of the pots.

In that way each location at the outer surface of the circumferential wall of each pot P is brushed once or several times, at intervals, and effectively cleaned, in particular when water is also supplied to the brush and/or pots.

Dirty water flows down along splashboard 17 in direction J, wherein the splashboard 17 extends downwards to such an extent that also in the uppermost position of the brushing unit 10 the bottom edge of splashboard 17 is below the belt 3.

The speed of the belt 3, rope belt 6, the rotation speed of the brush 14, the up-and-down stroke of the brush 14 and the speed of the up-and-down motion can be adjusted, in order to be adapted to the pot sizes and the degree of filthiness of the pots. By way of example the crank arm 26 has been provided with a second hole 25a for drive shaft 25 if the up-and-down stroke needs to be smaller. The height of the belt 3 can be adjusted as well, directions K.

The above description is included to illustrate the operation of preferred embodiments of the invention and not to limit the scope of the invention. Starting from the above explanation many variations that fall within the spirit and scope of the present invention will be evident to an expert.

1. Device for cleaning the outer surface of the circumferential wall of plant pots, comprising:
a frame;
a pot track arranged on the frame, which track extends from an input end to an output end and forms a support surface for the plant pots;
a movement device for moving the plant pots from the input end to the output end;
a rotation device for rotating the plant pots about their pot axis;
a brush for brushing the outer surface of the circumferential wall of the plant pots during said movement;
a first brush drive for rotating the brush about a lying axis; and
a second brush drive for moving the rotating brush up and down, while engaging the outer surface of the pot's circumferential wall, between a first position and a second position, wherein the first position is situated at a lower level than the second position.

2. Device according to claim 1, wherein the first and the second brush drives are operable for simultaneous action.

3. Device according to claim 1, wherein the first brush drive is configured for both in the upward stroke and in the downward stroke of the brush having the brush rotate with a vertical downward directional component at the location of the contact with the plant pots.

4. Device according to claim 1, wherein the second brush drive is configured for repeatedly moving the brush up and down in the period in which a plant pot is moved from the input end to the output end by the movement device.

5. Device according to claim 1, wherein the speed, the size and/or the level of the up-and-down stroke of the brush is adjustable relative to the pot track.

6. Device according to claim 1, wherein the rotation device is configured for continuously rotating the plant pots during their movement from the input end to the output end.

7. Device according to claim 1, wherein the rotation device comprises a circumferentially extending, elongated element, such as a belt, cord, chain or rope belt, which in an engagement path engages onto the circumferential wall of the plant pots, and comprise a drive for driving the elongated element in said engagement path in a direction that is the same as the movement direction of the plant pots.

8. Device according to claim 1, wherein the movement device comprises a driven belt conveyor, which forms the support surface for the plant pots.

9. Device according to claim 1, further comprising a water dispenser for providing water for the brushing process.

10. Device according to claim 1, wherein the brush is elongated and has a length of at least almost the distance between the input end and the output end.

11. Device according to claim 1, wherein the lying axis of the brush is parallel to the pot support surface of the pot track, in particular parallel to the movement direction of the pots on the pot track.

12. Method for cleaning the outer surface of the circumferential wall of plant pots having a pot axis, comprising the following steps:
moving the plant pots in series on a pot track;
using a rotating brush for brushing the outer surface of the circumferential wall of the plant pots during their movement on the pot track;
rotating the plant pots about their pot axis to allow the brush to be active all around the outer surface of the circumferential wall; and
moving the brush up and down during brushing.

13. Method according to claim 12, wherein the brush is moved up and down between a first position in which the axis of the brush is at least almost at the same height as the bottom edge of the pot wall and a second position in which the brush axis is at a higher level such that the brush engages the pot wall at a distance from the bottom edge.

14. Method according to claim 13, wherein the second position is at least almost at the same height as the upper edge of the pot wall.

15. Method according to claim 12, wherein during the movement of a plant pot over the pot track the brush is moved up and down relative to said plant pot several times.

16. Method according to claim 12, wherein the brush is rotated in rotation direction that is downward where the plant pots are being engaged by the brush.

17. Method according to claim 16, wherein the circumferential speed at the circumference of the brush, where it engages the outer surface of the circumferential wall of the pot, exceeds the largest speed with which the brush is moved upwards.

18. Method according to claim 12, wherein water is dispensed to the brush and/or the plant pots for washing the outer surface of the circumferential wall of the plant pots.

19. Method according to claim 12, wherein during their movement over the pot track the plant pots are continuously rotated about their pot axis.
